(19) United States
(12) Patent Application Publication
(10) Pub. No.: US 2003/0006366 A1
(43) Pub. Date: Jan. 9, 2003

(54) Tracking window and lens apparatus and process

(76) Inventor: Ray M. Alden, Raleigh, NC (US)

Correspondence Address: Ray M. Alden, 808 Lake Brandon Trail, Raleigh, NC, 27610, US

(21) Appl. No.: 09/901,448

(22) Filed: Jul. 9, 2001

(51) Int. Cl. G01J 1/20; G01C 21/02; H01J 3/14

(52) U.S. Cl. 250/216

(57) ABSTRACT

In a preferred embodiment, this application describes means for selecting what light trajectories will pass through a window, at what trajectory said selected electromagnetic energy will exit the window. Means are provided which enable the window to track an object and to select to receive light from that object on a first side of a window. Means are provided which enable the window to track an object and to select to pass light to that object on a second side of said window. Tracking means include remote control, radio signal emitters, position sensors, photo-senors, and a computer connected to the defection control mechanism of the window with operating and calculating software therein.

### BACKGROUND FIELD OF INVENTION

This invention relates to dynamic windows. More specifically, windows that are directional with regard to selecting from which direction light is accepted to pass therethrough. The window can also select which direction light will travel therefrom. The window also tracks objects on either side thereof. The window can be caused to provide a static view such that users each viewing the window from different perspectives share a common view.

### BACKGROUND-DESCRIPTION OF PRIOR INVENTION

The concept and process for creating a variable view window using variable prisms in series has been pioneered by the present inventor. Prior to the present inventor's work, one characteristic of all windows conceived heretofore is that the view provided therethrough is altered only when a user changes his position relative thereto. The present invention is a variable view window which pixelates the window such that a user can vary the view provided by the window. Additionally the present invention is connected with a computer and additional hardware which enables the window to track people on either side thereof, to track objects of known relationship to the window—such as the moon and sun, or to be otherwise alterable at the user's discretion. Thirdly, the present invention enables the users to select which view is provided by the window.

### SUMMARY

The invention described herein represents a significant new body of art relating to directional window technology. It enables a user to select the view provided by a window nearly instantaneously. It enables the window to track a user thereof to continuously ensure the view provided therethrough is correct. It enables the window to track objects outside thereof to ensure that light from those objects are consistently delivered to the user thereof It enables the window to track objects to ensure light therefrom is directed as desired. In a preferred embodiment, the optical technology disclosed herein includes a first window pane incorporating a focusing lens array therein and a second window plane incorporating a focusing lens array therein. An array of flexible light pipes carries light between the first pane and second pane. Each light pipe having a first end which can flexibly be positioned at a multitude of focus points corresponding to a multitude of light orientations and a second end which can flexibly be positioned at a multitude of focus points corresponding to a multitude of light orientations. Additionally incorporated are the hardware and software means to track users and objects on ether side of the window. Examples of hardware include radio transmitters, motion detectors, photo sensors, a computer processor, and remote controls. A range of views are possible through the window nearly instantly.

### OBJECTS AND ADVANTAGES

Accordingly, several objects and advantages of my invention are apparent. It is an object of the present invention to provide a window which is nearly instantly alterable with regard to the selection of what light trajectory angles will pass therethrough. This enables the user to select what view is provided by the window. It is an object of the present invention to provide a window which is nearly instantly alterable with regard to the selection of what light trajectory angles will pass therefrom. It is an object to provide a window which automatically tracks objects and people on either side thereof. It is an advantage to provide a window which achieves these objects with few moving parts such that predictable and efficient transferring and deflection of light is reliably achieved within a thin structure. The apparatus described is designed to be rugged, reliable, cost effective and to minimize resource requirement while being mass produced in any size or shape. It should be noted that the technology provided herein can be applied to any field which uses windows and/or lenses such as telecommunications switching, entertainment, photography, optics, science, engineering, telescopy, building architecture, automobiles, and etc.

### DRAWING FIGURES

FIG. 1 illustrates a cross section view of a single pixel cell of the present tracking window.

FIG. 2 includes a cross section view of a segment of light pipe and a non-cross section view of a segment of light pipe with two lenses.

FIG. 3 provides a view of the three dimensional actuating architecture. FIG. 4 illustrates a cross section view of a single pixel cell in a second configuration.

FIG. 5 shows three pixilated cells operation in unison.

FIG. 6 describes the pixilated window optical components in array.

FIG. 7 illustrates a second tracking means with computer operating the pixilated window.

FIG. 8 illustrates the pixilated window tracking the moon's view to a moving user.

FIG. 9 illustrates the pixilated window tracking the sun's light to a heat sink.

FIG. 10 sows a tracking window installed in a building's wall.

### DESCRIPTION

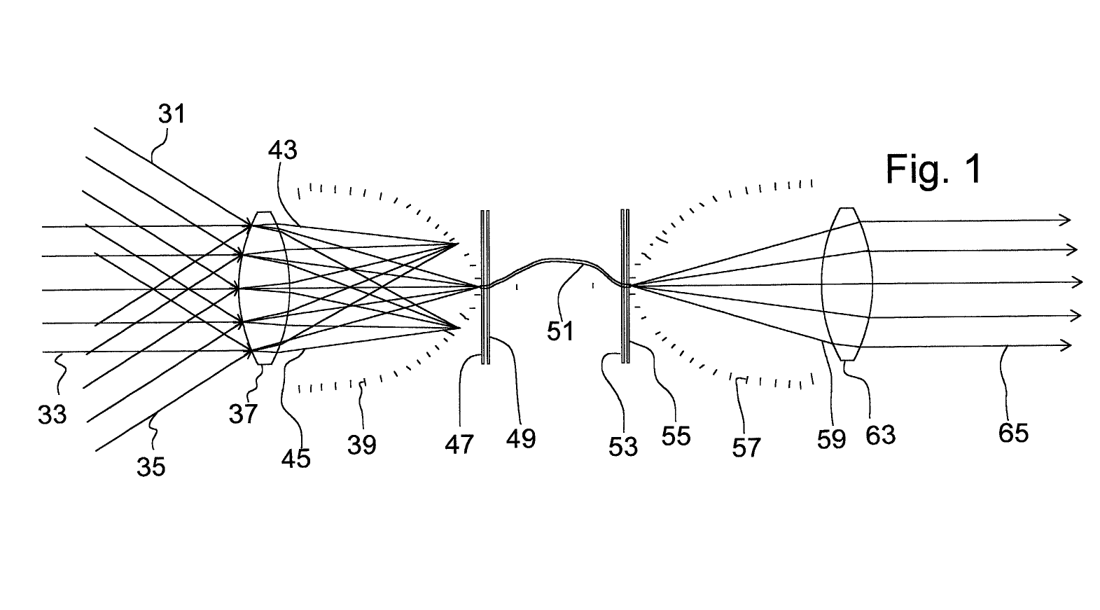

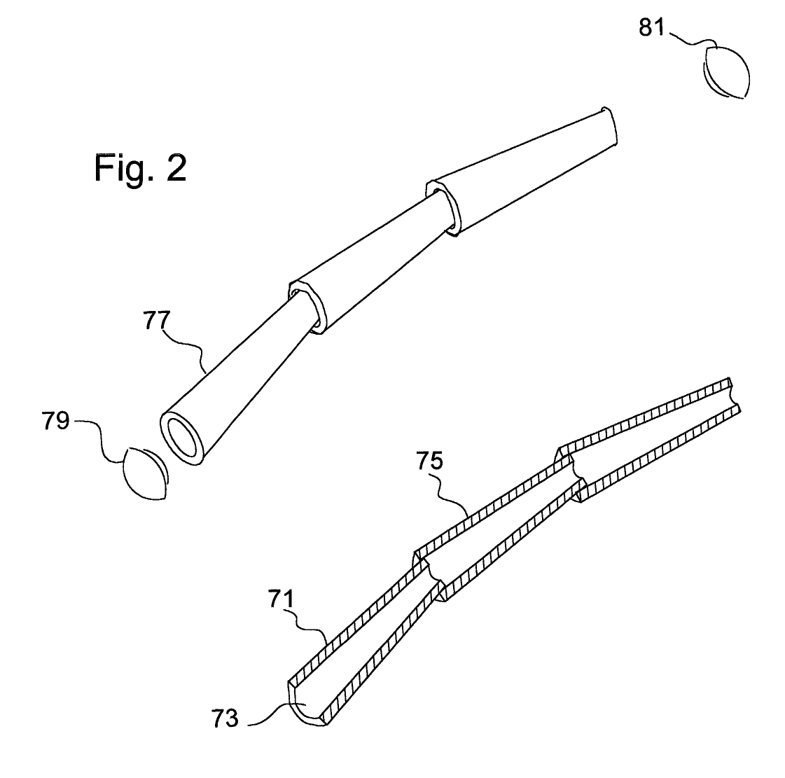

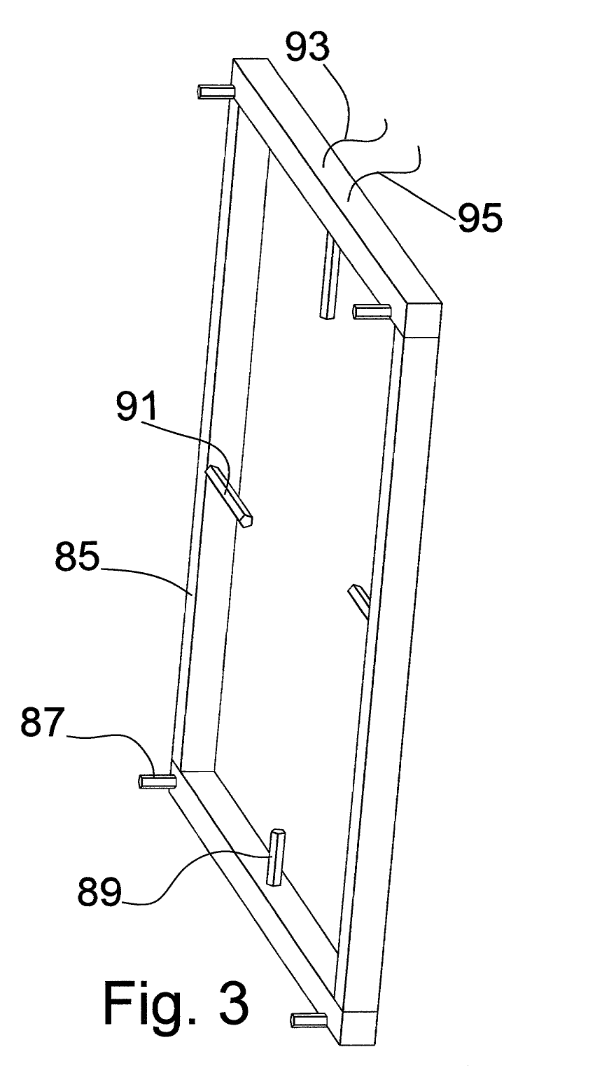

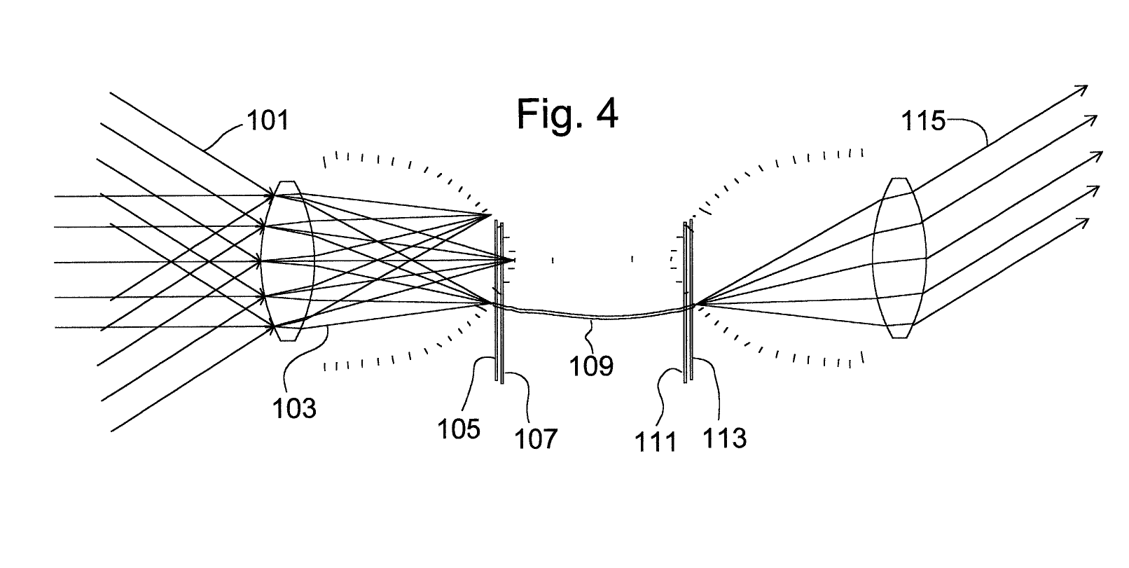

FIG. 1 illustrates a cross section view of a single pixel cell of the present tracking window. A first incident beam 31, a second incident beam 33, and a third incident beam 35 are representative of any number of beams that are incident on a first pixel lens 37. 37 is a focusing optic transparent in at least some of the electromagnetic spectrum. For parallel incident electromagnetic radiation or for point source incident electromagnetic radiation, 37 causes the former or the later to form focal points along one or more known curves such as a first focal point 39. Each relative orientation of incident radiation reaches a different respective focal point along the 39 curve (or a similar curve). (It should be noted that many of the “focal points” are not exact points but are instead definite convergence regions where the individual rays of common origin or of parallel orientation (prior to incidence on 37) tend to converge as a group.) A first positioning element 47 is a rigid piece that is connected to the first end of 51 and can be actuated (as discussed in FIG. 3) such that the first end of a transference element 51 is positioned along the 39 focal curve. 51 as further discussed in FIG. 2 is a substantially light transmissive element with narrow entry and exit parameters so as to be flexibly positioned to select what orientation of electromagnetic energy will pass therethrough. A first angular positioning element 49 is actuated (as discussed in FIG. 3) such that the angle of the first end of 51 corresponds to the average angle formed by the electromagnetic energy at a selected focal point thereby ensuring optimal light injection efficiency for selected electromagnetic energy and optimal omittance of undesirable electromagnetic energy. 47 and 49 can be actuated in three dimensions. In the illustration the 33 electromagnetic radiation is converging at the first end of 51 and is being passed therethrough. A second positioning element 55 is a rigid piece that is connected to the second end of 51. 55 actuates its end of 51 such that it can be positioned along a second focal curve 57. A second angular positioning element 53 is actuated to ensure that the angle at which the second end of 51 resides is optimal for transferring electromagnetic energy to a second optic 63. 63 is an element that causes the electromagnetic energy from 51 to exit in a desired way as exiting electromagnetic radiation 65. 65 can be parallel rays or it can be divergent rays depending on the positioning of the actuators.

FIG. 2 includes a cross section view of a segment of light pipe and a non-cross section view of a segment of light pipe with two lenses. A first segment in cross section 71 is a rigid light pipe with a highly reflective internal wall 73. One end of 71 is of larger diameter that a second end of 71 such that the second end can fit into a second identical segment 75. Note that the connection between segments such as 71 and 75 is a “sloppy” one such that these two segments can move into different planes relative to one another. Similar relationships with a number of such segments in series, enables the series to be flexible. A light pipe segment 77 is shown not cutaway. A first lens element 79 may be fit into an end of the series of light pipe segments and a second lens 81 may be fit into the second end of the series of light pipe segments. 51 of FIG. 1 is made of a series of segments similar to 77 and may have lens elements such as 79 and or 81 incorporated therein. The light pipe segments in series may be coated (exterior only) with an elastic material such as polyurethane (not shown) to ensure that they retain the ability to move into different relative planes while remaining cohesive (not falling apart). The light pipe segments can be manufactured from metal such as copper with silver interior plate for the high reflective interior within the visible spectrum or gold plate for the UV spectrum

FIG. 3 provides a view of the three dimensional actuating architecture. Each of the positioning elements such as 47, 49, 53, and 55 of FIG. 1 are individual controlled by respective structures similar to that in FIG. 3. A positioning signal wire harness 93 carries signals to the actuating unit from a computer (discussed later). These signals control the unit positioning to achieve desired results calculated by the user or by the computer. A power cord 95 carries the energy to operate the unit. Horizontal actuators such as first horizontal actuator 91 move the respective rigid positioning structure in the horizontal dimension. Vertical actuators such as first vertical actuator 89 move the respective rigid positioning structure in the vertical dimension. Depth actuators such as first depth actuator 89 move the respective rigid positioning structure to the optimal depth (closer or further from the respective lens). Using this actuation architecture enables the positioning units to position the light pipe (pipes) in the optimal alignment and angular orientation on both ends for optimal and flexible performance.

FIG. 4 illustrates a cross section view of a single pixel cell in a second configuration. The hardware is identical to that in FIG. 1 expect that the positioning elements have actuated the light pipe assembly into new alignments. A first offset positioning structure 105 together with a second offset positioning structure 107 have been actuated to position a reoriented light pipe 109 such that its first end receives the selected object light 101 at its focal point. 105 and 107 are relatively offset such that the angle formed by the first end of 109 is optimal for the 101 light injection into 109. Similarly, a second offset positioning element 111 and a second offset angular positing element 113 have been positioned to optimize the output of light and spread it across the output optic such that diverted light 115 emerges on a diverted trajectory.

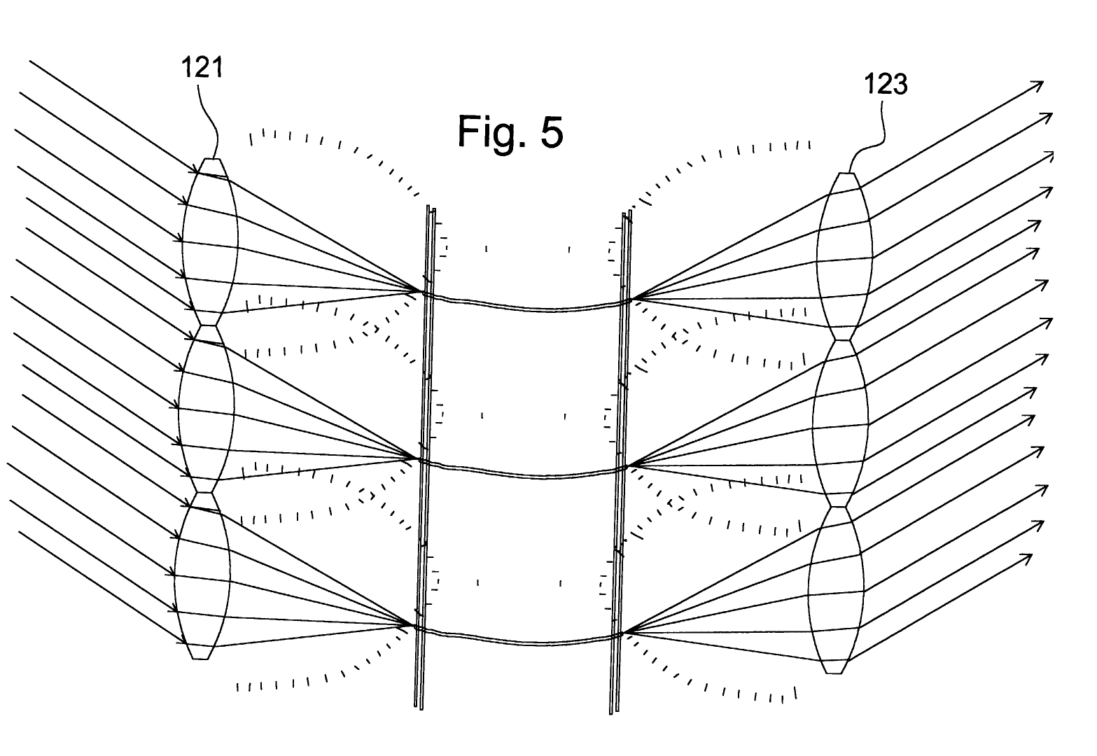

FIG. 5 shows three pixilated cells operating in unison. An array of first optical elements 121 receives incident electromagnetic radiation, arrayed identical to those in FIG. 4 then select the focal point for injection and for emitance such that light emerges form a second lens array 123 on a new diverted trajectory. It should be noted that each of the four rigid positioning components discussed in FIG. 4 are positioned corporately when in array, thus four sets of actuators positions the three respective light pipes shown.

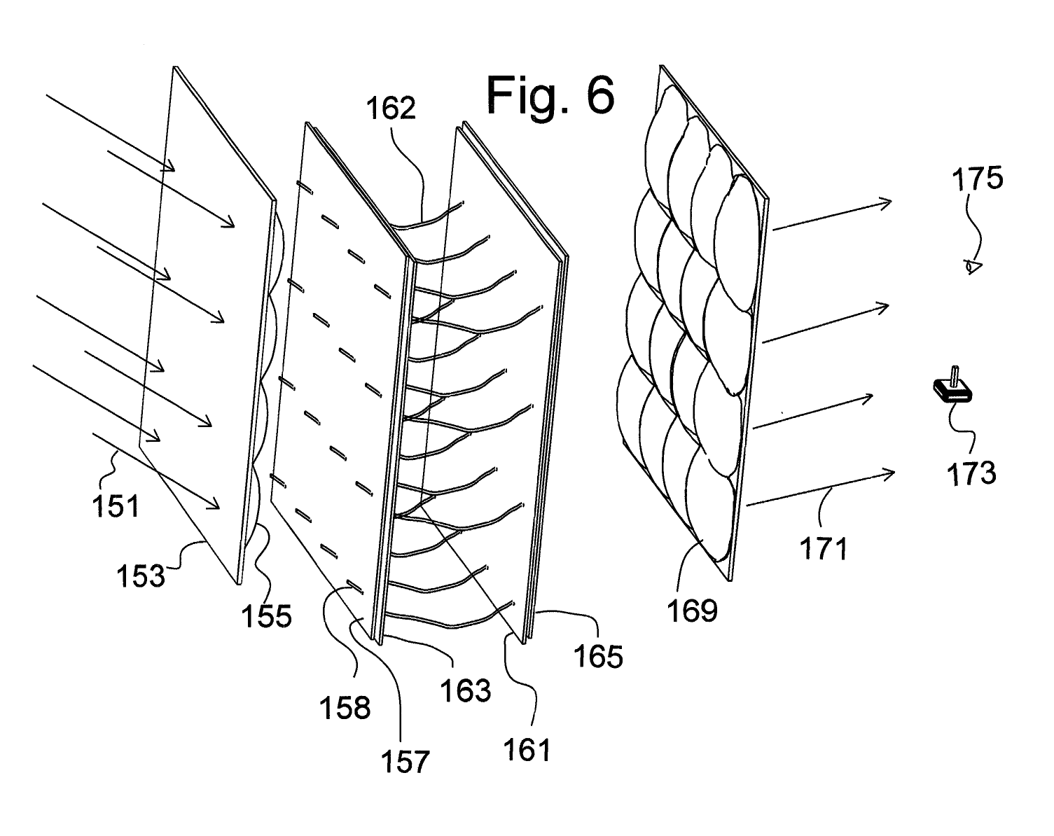

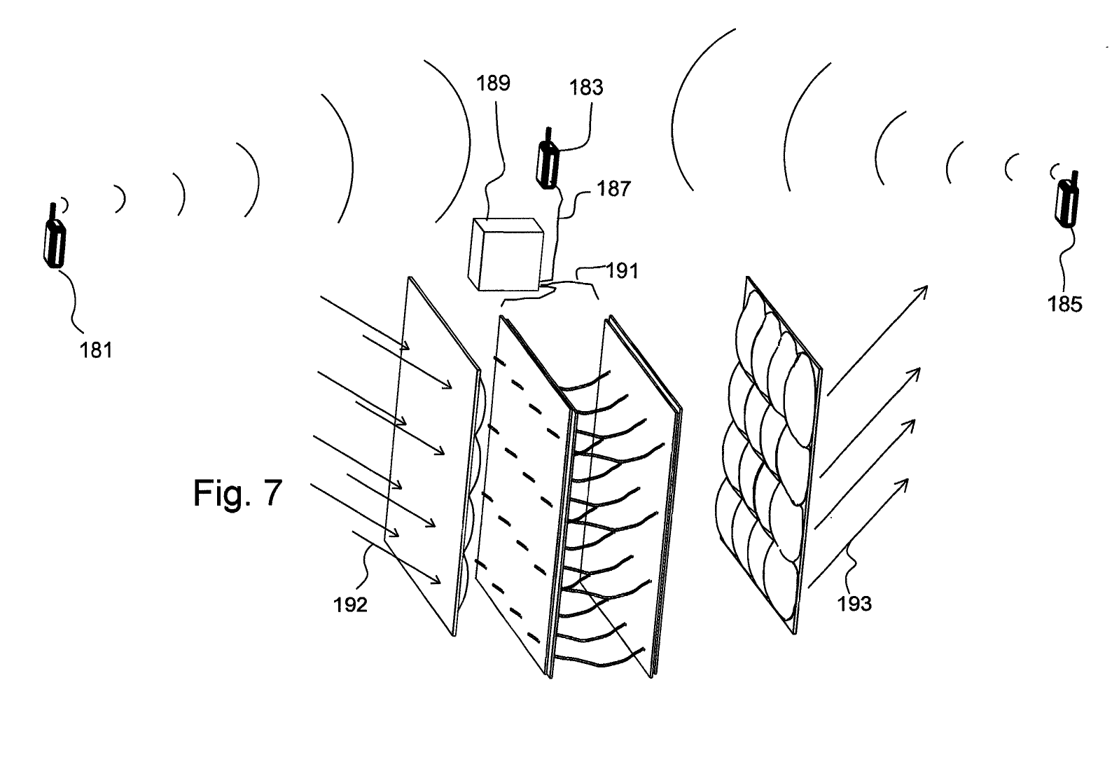

FIG. 6 describes the pixilated window optical components in array. The elements of FIG. 6 are the same as those in FIG. 4 except they are now show in three dimensional array. Selected incident light 151 is incident on a first window pane 153 which has a lens array incorporated therein with lenses similar to a first corporate lens 155. 155 and the other lenses in the 153, cause nearly all of the 151 incident light to form a series of foci such that light pipe ends such as a first light pipe end 158 receive nearly all of the 151 light. 158 and all of the similar light pipe ends having been actuated into position by a first array actuator 157 and a second array actuator 163. Example light pipe 162 and the similar light pipes carries nearly all of the 151 and passes it to a second pane 171 which has a series of second lens incorporated therein such as a second lens in array 169. A first user 175 can actuate the elements of the unit at will using a remote control joystick 173. Thus the user sees the object on the other side of the window that she desires to. 153 and the 169 can be molded glass or plastic or can be extruded. The 155 and 169 lenses can be convex, concave, gradient index or any other converging optic. The 162 can be a flexible series of light pipes as previously discussed or any other substantially light transmissive element.

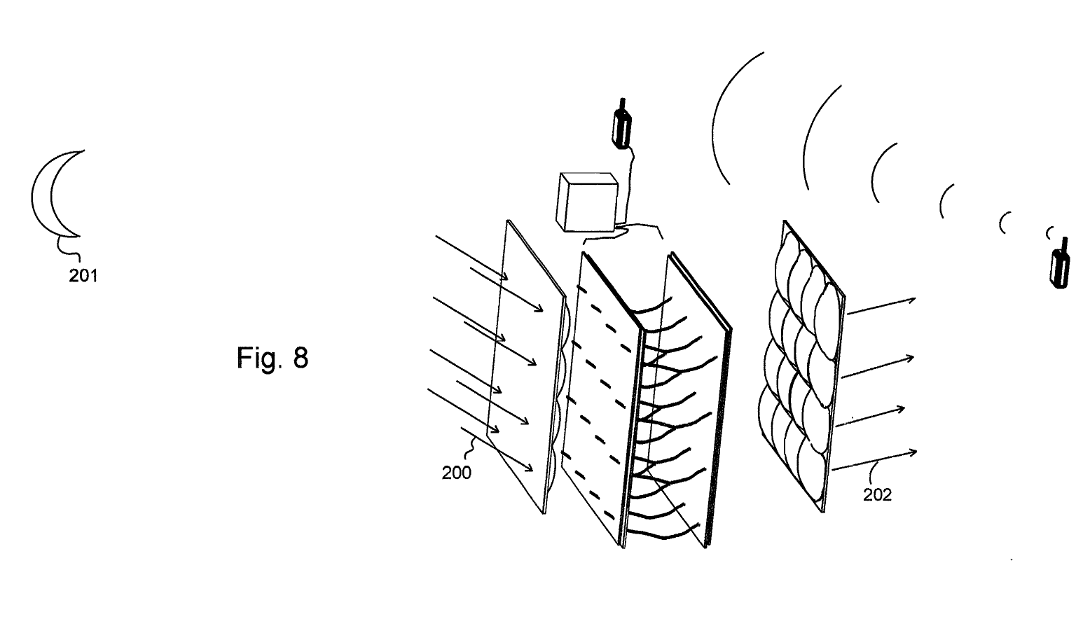

FIG. 7 illustrates a second tracking means with computer operating the pixilated window. FIG. 7 has the identical optical elements as FIG. 6. A first transmitter 181 is worn by a child on the first side of the tracking window unit. It sends a signal to a receiver/transducer 183. The receiver, transducer sends information to a computer 189 which calculates the actuation required in order for light from the child 192 to be received optimally and transferred by the window unit. A second transmitter 185 is worn by an adult interested in supervising the child. It sends a signal to the 183 receiver/transducer which in turn sends a signal to the computer. The computer then calculates the actuation required to send light to the adult 193. The window in this configuration will keep the child in the view of the adult as each of them move independently on either side of the window. The computer sends the positioning information to the actuating element via wire to actuating elements 191. The four actuating elements (not shown) are similar to those in FIG. 3 but are omitted for simplicity.

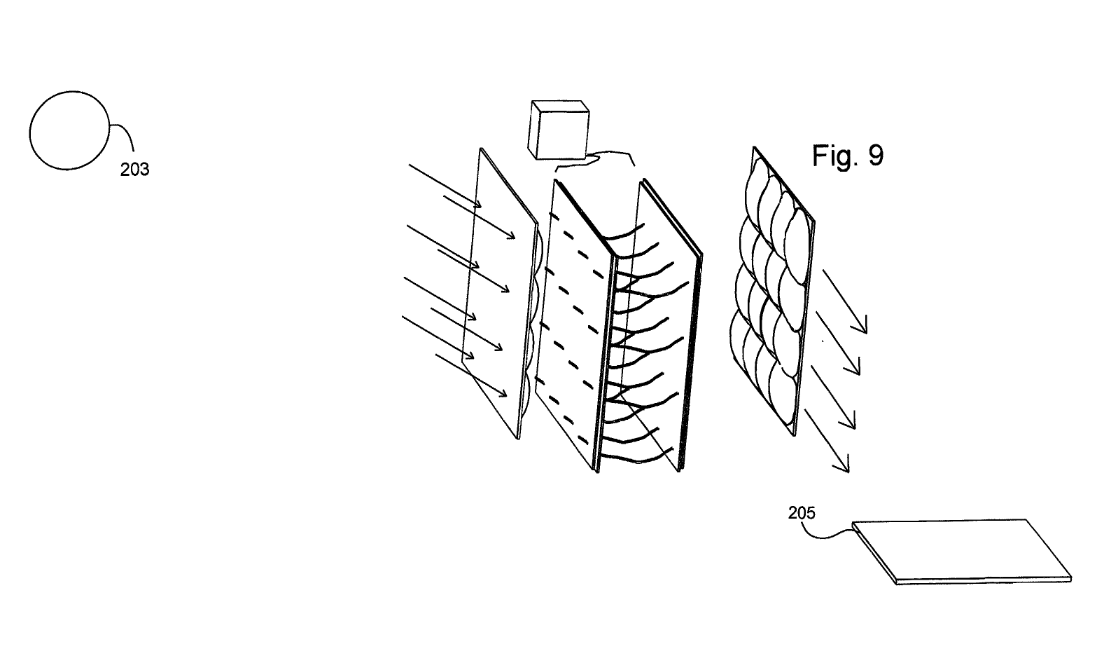

FIG. 8 illustrates the pixilated window tracking the moon's view to a moving user. A moon 201 is tracked as it moves across the sky using computer software. Moon light 200 is thereby collected by the window. The window knows the user's location using the transmitter of FIG. 7. Moon light to the user 202 will therefore be provided as long as the moon is in view of the window and even as the user moves around on the other side of the window.

FIG. 9 illustrates the pixilated window tracking the sun's light to a heat sink. The computer can be programmed to track the sun 203 across the sky. In the winter, sun light can be directed to a heat sink 205 such that heat energy can be stored and warm the house over an extended time. The position of 205 is stored into the computer's memory such that the light can be directed to it at will.

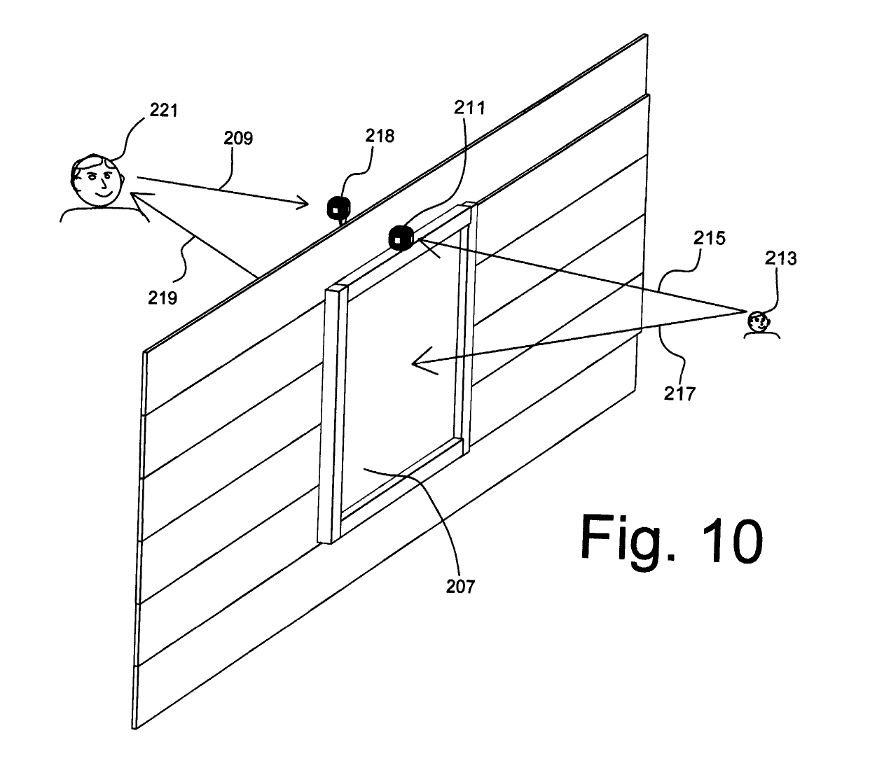

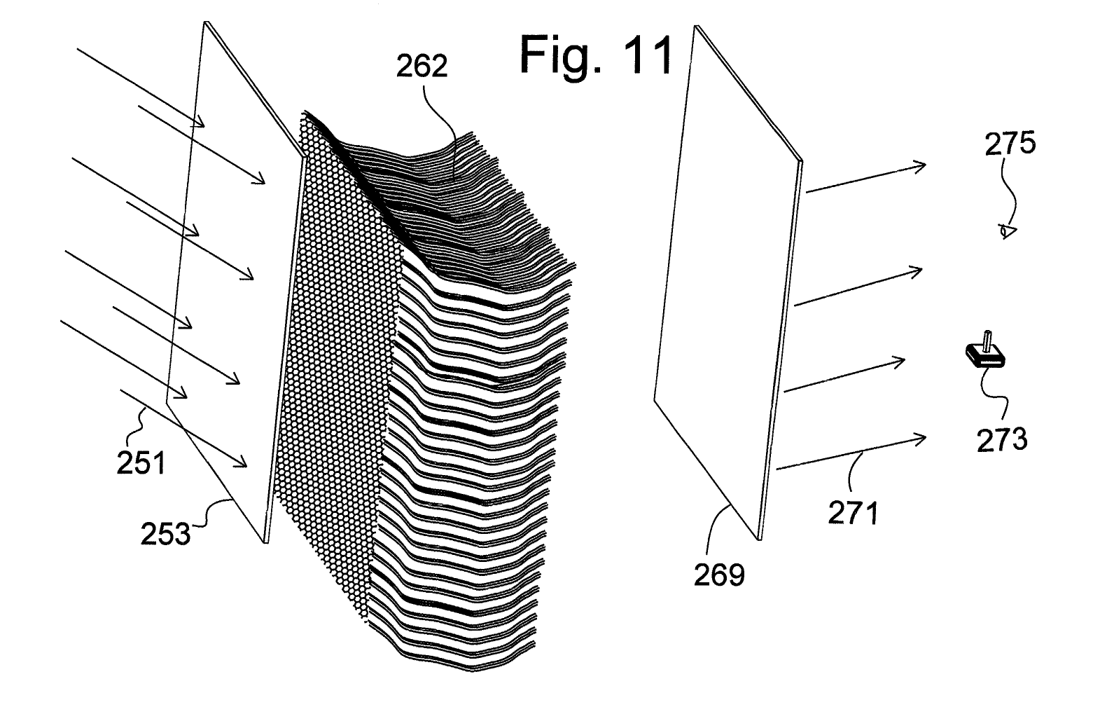

FIG. 10 sows a tracking window207 installed in a building's wall. On the outside of the building, a child 213 plays. An external sensor 211 tracks the child's position using infrared radiation 215 and reports the location to a computer. The computer calculates the necessary actuation and sends the signal to the actuators to position the flexible light pipes to receive light from the child 217. An interior sensor 218 tracks the position of a father 221 using interior infrared radiation 209. The father's location is transferred to the computer which calculates actuation required and sends positioning instructions to the actuators such that light from the child is brought to the father 219. Thus the window can track the child and track the father such that the light from the child is brought to the father even as both change positions. Object's can similarly be tracked from with an automobile.

FIG. 11 illustrates that a dense array 262 of light pies or other substantially light transmissive elements can be used in replacement of an focusing optics. The dense array is actuated similarly to the method previously discussed such that each pipe is receiving light from a desired location as desired light 251. A non focusing glass pane 253 is transmissive in the desired spectrum. The 262 transferred the majority of light to a user 275. Said light having passed through a second non-focusing pane 269 as exiting light 271. The user can use a remote control 273 or any of the tracking components previously discussed. The 262 array can be light pipes, or fiber optic fibers, actuated using the aforementioned technique. Additionally, the 262 array can be liquid crystal actuated using electric or magnetic fields or by other methodology.

Operation of the Invention

FIG. 1 illustrates a cross section view of a single pixel cell of the present tracking window.

A first incident beam 31, a second incident beam 33, and a third incident beam 35 are representative of any number of beams that are incident on a first pixel lens 37. 37 is a focusing optic transparent in at least some of the electromagnetic spectrum. For parallel incident electromagnetic radiation or for point source incident electromagnetic radiation, 37 causes the former or the later to form focal points along one or more known curves such as a first focal point 39. Each relative orientation of incident radiation reaches a different respective focal point along the 39 curve (or a similar curve). (It should be noted that many of the “focal points” are not exact points but are instead definite convergence regions where the individual rays of common origin or of parallel orientation (prior to incidence on 37) tend to converge as a group.) A first positioning element 47 is a rigid piece that is connected to the first end of 51 and can be actuated (as discussed in FIG. 3) such that the first end of a transference element 51 is positioned along the 39 focal curve. 51 as further discussed in FIG. 2 is a substantially light transmissive element with narrow entry and exit parameters so as to be flexibly 15′ positioned to select what orientation of electromagnetic energy will pass therethrough. A first angular positioning element 49 is actuated (as discussed in FIG. 3) such that the angle of the first end of 51 corresponds to the average angle formed by the electromagnetic energy at a selected focal point thereby ensuring optimal light injection efficiency for selected electromagnetic energy and optimal omittance of undesirable electromagnetic energy. 47 and 49 can be actuated in three dimensions. In the illustration the 33 electromagnetic radiation is converging at the first end of 51 and is being passed there through. A second positioning element 55 is a rigid piece that is connected to the second end of 51. 55 actuates its end of 51 such that it can be positioned along a second focal curve 57. A second angular positioning element 53 is actuated to ensure that the angle at which the second end of 51 resides is optimal for transferring electromagnetic energy to a second optic 63. 63 is an element that causes the electromagnetic energy from 51 to exit in a desired way as exiting electromagnetic radiation 65. 65 can be parallel rays or it can be divergent rays depending on the positioning of the actuators.

FIG. 2 includes a cross section view of a segment of light pipe and a non-cross section view of a segment of light pipe with two lenses. A first segment in cross section 71 is a rigid light pipe with a highly reflective internal wall 73. One end of 71 is of larger diameter that a second end of 71 such that the second end can fit into a second identical segment 75. Note that the connection between segments such as 71 and 75 is a “sloppy” one such that these two segments can move into different planes relative to one another. Similar relationships with a number of such segments in series, enables the series to be flexible. A light pipe segment 77 is shown not cutaway. A first lens element 79 may be fit into an end of the series of light pipe segments and a second lens 81 may be fit into the second end of the series of light pipe segments. 51 of FIG. 1 is made of a series of segments similar to 77 and may have lens elements such as 79 and or 81 incorporated therein. The light pipe segments in series may be coated (exterior only) with an elastic material such as polyurethane (not shown) to ensure that they retain the ability to move into different relative planes while remaining cohesive (not falling apart). The light pipe segments can be manufactured from metal such as copper with silver interior plate for the high reflective interior within the visible spectrum or gold plate for the UV spectrum.

FIG. 3 provides a view of the three dimensional actuating architecture. Each of the positioning elements such as 47, 49, 53, and 55 of FIG. 1 are individual controlled by respective structures similar to that in FIG. 3. A positioning signal wire harness 93 carries signals to the actuating unit from a computer (discussed later). These signals control the unit positioning to achieve desired results calculated by the user or by the computer. A power cord 95 carries the energy to operate the unit. Horizontal actuators such as first horizontal actuator 91 move the respective rigid positioning structure in the horizontal dimension. Vertical actuators such as first vertical actuator 89 move the respective rigid positioning structure in the vertical dimension. Depth actuators such as first depth actuator 89 move the respective rigid positioning structure to the optimal depth (closer or further from the respective lens). Using this actuation architecture enables the positioning units to position the light pipe (pipes) in the optimal alignment and angular orientation on both ends for optimal and flexible performance.

FIG. 4 illustrates a cross section view of a single pixel cell in a second configuration. The hardware is identical to that in FIG. 1 expect that the positioning elements have actuated the light pipe assembly into new alignments. A first offset positioning structure 105 together with a second offset positioning structure 107 have been actuated to position a reoriented light pipe 109 such that its first end receives the selected object light 101 at its focal point. 105 and 107 are relatively offset such that the angle formed by the first end of 109 is optimal for the 101 light injection into 109. Similarly, a second offset positioning element 111 and a second offset angular positing element 113 have been positioned to optimize the output of light and spread it across the output optic such that diverted light 115 emerges on a diverted trajectory.

FIG. 5 shows three pixilated cells operating in unison. An array of first optical elements 121 receives incident electromagnetic radiation, arrayed identical to those in FIG. 4 then select the focal point for injection and for emitance such that light emerges form a second lens array 123 on a new diverted trajectory. It should be noted that each of the four rigid positioning components discussed in FIG. 4 are positioned corporately when in array, thus four sets of actuators positions the three respective light pipes shown.

FIG. 6 describes the pixilated window optical components in array. The elements of FIG. 6 are the same as those in FIG. 4 except they are now show in three dimensional array. Selected incident light 151 is incident on a first window pane 153 which has a lens array incorporated therein with lenses similar to a first corporate lens 155. 155 and the other lenses in the 153, cause nearly all of the 151 incident light to form a series of foci such that light pipe ends such as a first light pipe end 158 receive nearly all of the 151 light. 158 and all of the similar light pipe ends having been actuated into position by a first array actuator 157 and a second array actuator 163. Example light pipe 162 and the similar light pipes carries nearly all of the 151 and passes it to a second pane 171 which has a series of second lens incorporated therein such as a second lens in array 169. A first user 175 can actuate the elements of the unit at will using a remote control joystick 173. Thus the user sees the object on the other side of the window that she desires to. 153 and the 169 can be molded glass or plastic or can be extruded. The 155 and 169 lenses can be convex, concave, gradient index or any other converging optic. The 162 can be a flexible series of light pipes as previously discussed or any other substantially light transmissive element.

FIG. 7 illustrates a second tracking means with computer operating the pixilated window. FIG. 7 has the identical optical elements as FIG. 6. A first transmitter 181 is worn by a child on the first side of the tracking window unit. It sends a signal to a receiver/transducer 183. The receiver, transducer sends information to a computer 189 which calculates the actuation required in order for light from the child 192 to be received optimally and transferred by the window unit. A second transmitter 185 is worn by an adult interested in supervising the child. It sends a signal to the 183 receiver/transducer which in turn sends a signal to the computer. The computer then calculates the actuation required to send light to the adult 193. The window in this configuration will keep the child in the view of the adult as each of them move independently on either side of the window. The computer sends the positioning information to the actuating element via wire to actuating elements 191. The four actuating elements (not shown) are similar to those in FIG. 3 but are omitted for simplicity.

FIG. 8 illustrates the pixilated window tracking the moon's view to a moving user. A moon 201 is tracked as it moves across the sky using computer software. Moon light 200 is thereby collected by the window. The window knows the user's location using the transmitter of FIG. 7. Moon light to the user 202 will therefore be provided as long as the moon is in view of the window and even as the user moves around on the other side of the window.

FIG. 9 illustrates the pixilated window tracking the sun's light to a heat sink. The computer can be programmed to track the sun 203 across the sky. In the winter, sun light can be directed to a heat sink 205 such that heat energy can be stored and warm the house over an extended time. The position of 205 is stored into the computer's memory such that the light can be directed to it at will.

FIG. 10 sows a tracking window207 installed in a building's wall. On the outside of the building, a child 213 plays. An external sensor 211 tracks the child's position using infrared radiation 215 and reports the location to a computer. The computer calculates the necessary actuation and sends the signal to the actuators to position the flexible light pipes to receive light from the child 217. An interior sensor 218 tracks the position of a father 221 using interior infrared radiation 209. The father's location is transferred to the computer which calculates actuation required and sends positioning instructions to the actuators such that light from the child is brought to the father 219. Thus the window can track the child and track the father such that the light from the child is brought to the father even as both change positions. Object's can similarly be tracked from with an automobile.

FIG. 11 illustrates that a dense array 262 of light pies or other substantially light transmissive elements can be used in replacement of an focusing optics. The dense array is actuated similarly to the method previously discussed such that each pipe is receiving light from a desired location as desired light 251. A non focusing glass pane 253 is transmissive in the desired spectrum. The 262 transferred the majority of light to a user 275. Said light having passed through a second non-focusing pane 269 as exiting light 271. The user can use a remote control 273 or any of the tracking components previously discussed. The 262 array can be light pipes, or fiber optic fibers, actuated using the aforementioned technique. Additionally, the 262 array can be liquid crystal actuated using electric or magnetic fields or by other methodology.

Conclusions, Ramifications, and Scope

Accordingly, several objects and advantages of my invention are apparent. It is an object of the present invention to provide a window which is nearly instantly alterable with regard to the selection of what light trajectory angles will pass therethrough. This enables the user to select what view is provided by the window. It is an object of the present invention to provide a window which is nearly instantly alterable with regard to the selection of what light trajectory angles will pass therefrom. It is an object to provide a window which automatically tracks objects and people on either side thereof. It is an advantage to provide a window which achieves these objects with few moving parts such that predictable and efficient transferring and deflection of light is reliably achieved within a thin structure. The apparatus described is designed to be rugged, reliable, cost effective and to minimize resource requirement while being mass produced in any size or shape. It should be noted that the technology provided herein can be applied to any field which uses windows and/or lenses such as telecommunications switching, entertainment, photography, optics, science, engineering, telescopy, building architecture, automobiles, and etc.

It should be noted that other configurations are possible using the art described herein. While my above description describes many specifications, these should not be construed as limitations on the scope of the invention, but rather as an exemplification of one preferred embodiment thereof. Many other variations are possible.

I claim:

1. An optical system comprising;
a means for tracking an object on a first side of an optical system,
a means for selecting the light from said object,
a means for passing said light through at least one component of said optical system, wherein
said light is caused to exit said optical system on an altered trajectory.

2. The optical system of claim 1, wherein a sensor receiving electromagnetic energy is used to track said object.

3. The optical system of claim 1, wherein a computer calculates how at least one optical element must be configured in order to alter said light's trajectory.

4. The optical system of claim 1, wherein said optical system is mounted in the wall of a building.

5. The optical system of claim 1 wherein said optical system is mounted in a conveyance.

6. A method for redirecting the course of electromagnetic radiation comprising;
a means for identifying the location of an object on a first side of a window,
a means for selecting said object's electromagnetic energy, and
a means for altering the course of said object's electromagnetic energy.

7. The optical system of claim 6, wherein a sensor receiving electromagnetic energy is used to track said object.

8. The optical system of claim 6, wherein a computer calculates how at least one optical element must be configured in order to alter said light's trajectory.

9. The optical system of claim 6, wherein said optical system is mounted in the wall of a building.

10. The optical system of claim 6, wherein said optical system is mounted in a conveyance.

11. A method for deflecting electromagnetic energy,
a means for selecting an incident stream of said energy,
a means for changing the course of said stream, and
a means for redirecting said stream on a new trajectory.

12. The optical system of claim 11, wherein a sensor receiving electromagnetic energy is used to track said object.

13. The optical system of claim 11, wherein a computer calculates how at least one optical element must be configured in order to alter said light's trajectory.

14. The optical system of claim 11, wherein said optical system is mounted in the wall of a building.

15. The optical system of claim 11, wherein said optical system is mounted in a conveyance.
